(19) United States
(12) Patent Application Publication
(10) Pub. No.: US 2009/0126182 A1
(43) Pub. Date: May 21, 2009

(54) Separator, process for producing separator, and apparatus for producing separator

(76) Inventors: Tomokazu Hayashi, Aichi (JP); Hirofumi Inoshita, Aichi (JP); Yusuke Watanabe, Aichi (JP)

Correspondence Address: KENYON & KENYON LLP, 1500 K STREET N.W., SUITE 700, WASHINGTON, DC, 20005, US

(21) Appl. No.: 11/921,643

(22) PCT Filed: Jun. 21, 2006
(86) PCT No.: PCT/JP2006/312843

§ 371 Date: Dec. 6, 2007

(30) Foreign Application Priority Data
Jun. 21, 2005 (JP) 2005-181220

(51) Int. Cl. B23P 17/00

(52) U.S. Cl. 29/592

(57) ABSTRACT

A process for producing a separator having a fluid channel on at least one side and a manifold communicating with the fluid channel and formed by punching, the process comprises a step of diminishing burrs in the manifold formed by the punching. When this step of diminishing the burrs is followed by the step of applying a coat-forming material to the part where burrs have been diminished, for example, a thermosetting coat-forming material is used as the coat-forming material, and the step of heating the coat-forming material from the side of a separator base may be added.

### BACKGROUND OF THE INVENTION

1. Technical Field

The present invention relates to a separator for use in a fuel cell, a process for producing the separator and an apparatus for producing the separator. More particularly, it relates to a technology of inhibiting deterioration of corrosion resistance of a separator in which a manifold is formed by punching.

2. Description of Related Art

For example, a solid polymer electrolyte fuel cell is constituted of a membrane electrode assembly (hereinafter referred to as the MEA) including an electrolytic film and a pair of electrodes disposed at opposite surfaces of the film, and a pair of separators which nip the MEA therebetween. Each separator is provided with a fluid channel extending along a surface direction and a manifold communicating with the fluid channel and extending through the separator.

An inner peripheral surface and an opening end surface of the manifold touch cooling water and produced water. Therefore, when a metal separator including a separator base made of a metal is used as the separator, a corrosion-resistant coating needs to be applied in order to prevent corrosion. For example, in Japanese Patent Application Laid-Open No. 11-297337, a technology is disclosed in which after pressing the metal separator, a resin coating is applied to the surface of the separator.

### SUMMARY OF THE INVENTION

Now, when a manifold is formed by punching during pressing, blade-like burrs are formed at an end surface of a punched portion on a front side in a punching direction. Therefore, even when a corrosion-resistant coat-forming material is applied to the whole separator, the coat-forming material does not stick to the burrs well as compared with another portion, and hence the burrs are sometimes exposed. In such a case, corrosion of the separator proceeds from the burrs as starting points, and a problem of deterioration of durability and performance of a fuel cell is caused.

Moreover, even when the burrs are not formed at the end surface of the punched portion, the coat-forming material applied to the surface of a separator base unavoidably contracts during hardening. Therefore, at an edge portion at which an inner peripheral surface and the end surface of the punched portion cross each other, the coat-forming material is pulled so as to come away from the edge portion along the respective surfaces, and resultantly the edge portion is sometimes exposed. In such a case, the corrosion of the separator proceeds from this edge portion as a starting point, and a problem similar to the above-mentioned problem is caused.

It is to be noted that even when the separator is used without applying any corrosion-resistant coating to the separator, the corrosion of the separator proceeds from the burrs as the starting points, and a problem similar to the above-mentioned problem is sometimes caused.

The present invention has been developed in view of the above-mentioned situation, and an object is to inhibit deterioration of corrosion resistance of a separator including a manifold formed by punching and having a coat layer on the surface thereof.

To achieve the above-mentioned object, the present invention is a process for producing a separator having a fluid channel on at least one side and a manifold communicating with the fluid channel and formed by punching, the process comprises a step of diminishing burrs in the manifold formed by the punching.

According to such a constitution, even when the burrs are formed at the manifold by the punching, the burrs are diminished beforehand, whereby concentration of a corrosive current on the burrs as starting points can be inhibited.

For example, in the step of diminishing the burrs, at least protrusions of the burrs may be dissolved by etching or the like, or an external force may be applied to protrusions of the burrs to deform the protrusions by at least one of: pressing, shot blasting and cutting, thereby diminishing the burrs.

The process may further comprise a step of applying a coat-forming material to at least a burr diminished part where the burrs have been diminished.

A thermosetting resin may be used as the coat-forming material, and the process may further comprise the step of applying the coat-forming material being followed by a step of heating the coat-forming material from the side of a separator base.

The present invention is a process for producing a separator having a fluid channel on at least one side and a manifold communicating with the fluid channel and formed by punching, the process comprises a step of applying a thermosetting coat-forming material to at least a punched portion of the manifold; and a step of heating the coat-forming material from the side of a separator base.

A separator according to the present invention is a separator having a fluid channel on at least one side and a manifold communicating with the fluid channel and formed by punching, the separator comprises a burr diminished part where burrs in the manifold formed by the punching have been diminished.

According to such a constitution, concentration of a corrosive current on the burrs in the manifold as starting points can be inhibited.

An apparatus for producing a separator according to the present invention is an apparatus for producing a separator having a fluid channel on at least one side and a manifold communicating with the fluid channel and formed by punching, the apparatus comprises a burr diminishing treatment section that diminishes burrs in the manifold formed by the punching.

According to such a constitution, even when the burrs are formed at the manifold by the punching, the burrs are diminished beforehand by the burr diminishing treatment section, so that concentration of a corrosive current on the burrs as starting points can be inhibited.

The burr diminishing treatment section may, for example, dissolve at least protrusions of the burrs by etching, or apply an external force to the protrusions of the burrs to deform the protrusions by at least one of: pressing, shot blasting and cutting, thereby diminishing the burrs.

Moreover, the present invention is a process for producing a separator having a fluid channel on at least one side, a manifold formed so as to communicate with the fluid channel, and a coat layer on the surface of a separator base, the process comprises a step of forming the manifold at the separator base by punching; a step of removing burrs from an end surface of a punched portion; and a step of applying a coat-forming material to at least a part where the burrs have been removed.

According to such a constitution, even when the burrs are formed at the separator base by the punching, the burrs are inhibited from being exposed from the coat-forming material. Since the manifold is formed by the punching before applying the coat-forming material, unlike a case where the coat-forming material is applied before forming the manifold by the punching, an inner peripheral surface of the punched portion is not exposed.

A thermosetting resin may be used as the coat-forming material, and the step of applying the coat-forming material may be followed by a step of heating the coat-forming material from the side of a separator base.

According to such a constitution, the coat-forming material applied to the punched portion does not harden from the side of an outer surface of the material, but hardens from the side of an inner surface (the side of the surface of the separator base) to the side of the outer surface, so that the coat-forming material applied to the separator base is more securely fixed, and the edge portion of the punched portion is inhibited from being exposed by contraction of the coat-forming material during the hardening.

The present invention is a process for producing a separator having a fluid channel on at least one side, a manifold formed so as to communicate with the fluid channel, and a coat layer on the surface of a separator base, the process comprising: a step of forming the manifold at the separator base by punching; a step of applying a thermosetting coat-forming material to at least a punched portion; and a step of heating the coat-forming material from the side of the separator base.

According to such a constitution, the thermosetting coat-forming material applied to the punched portion does not harden from the side of an outer surface of the material, but hardens from the side of an inner surface (the side of the surface of the separator base) to the side of the outer surface, so that the coat-forming material applied to the separator base is more securely fixed, and the edge portion of the punched portion is inhibited from being exposed by the contraction of the coat-forming material during the hardening.

### BRIEF DESCRIPTION OF THE DRAWINGS

FIG. 1 is a perspective view showing a fuel cell to which a process for producing a separator is applied according to one embodiment of the present invention;

FIG. 2 is a sectional view of the fuel cell, and is a diagram showing a constitution of two adjacent cells;

FIG. 3 is an enlarged sectional view showing a punched portion and a periphery of the portion;

FIG. 4 is an enlarged sectional view of a main part showing a state in which burrs formed at the punched portion are removed, and then a corrosion-resistant coat-forming material is applied to this burr removed part;

FIG. 5 is an enlarged sectional view of a main part showing a state in which an edge portion of the punched portion is flatly chamfered;

FIG. 6 is an enlarged sectional view of a main part showing a state in which an edge portion of the punched portion is roundly chamfered;

FIG. 7 is a sectional view showing a state in which the corrosion-resistant coat-forming material is applied to the punched portion before the coat-forming material is thermally set;

FIG. 8 is a sectional view showing a state in which the corrosion-resistant coat-forming material applied to the punched portion is thermally set;

FIG. 9 is a sectional view schematically showing a process for producing a separator according to a second embodiment; and

FIG. 10 is a constitution diagram schematically showing one embodiment of an apparatus for producing the separator according to the present invention.

### DETAILED DESCRIPTION OF PREFERRED EMBODIMENT

A separator according to a preferable embodiment of the present invention, a process for producing the separator and an apparatus for producing the separator will hereinafter be described with reference to the accompanying drawings. As an example, a solid polymer electrolytic type fuel cell preferably mounted on a vehicle, to which the embodiments are applied, will hereinafter be described.

### First Embodiment

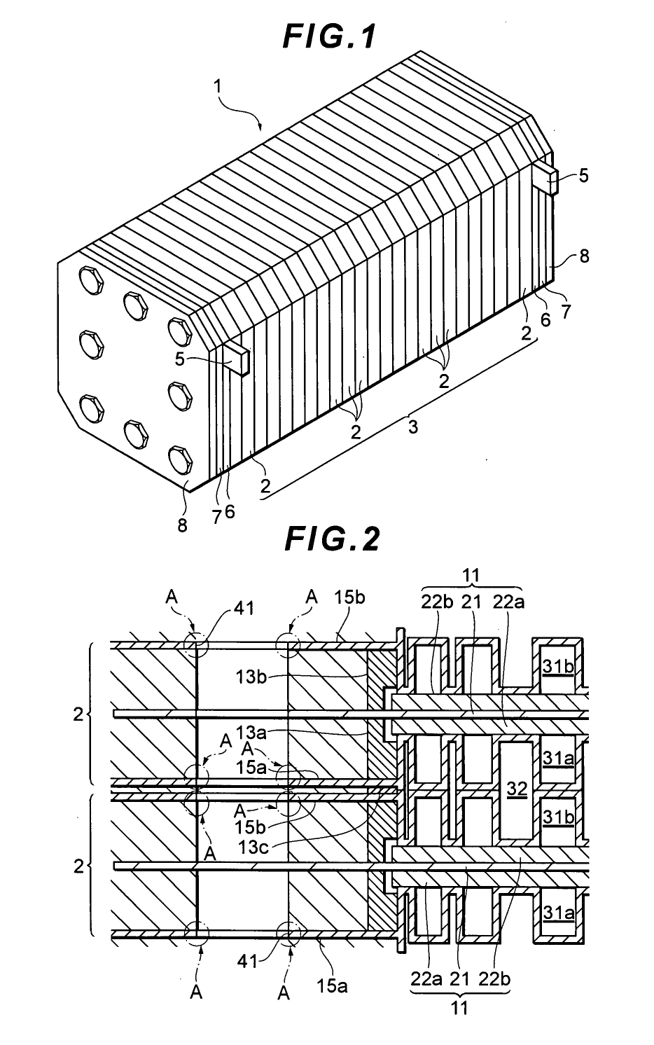

As shown in FIG. 1, a fuel cell 1 has a stack main body 3 in which a plurality of cells 2 are laminated, and on outer sides of the cells 2, 2 positioned at opposite ends of the stack main body 3, current collector plates 6 provided with output terminals 5, insulating plates 7 and end plates 8 are successively arranged, respectively. In the fuel cell 1, both of the end plates 8, 8 are fastened together with, for example, tension bolts extending through the cells 2 in a laminating direction, whereby a state is obtained in which a predetermined compressive force is applied in the laminating direction of the cells 2.

It is to be noted that instead of the above-mentioned tension bolts, a tension plate disposed so as to be bridged between the end plates 8 and 8 may be used, and this tension plate is fixed to the end plates 8, 8 with bolts, so that a predetermined compressive force can be applied in the laminating direction of the cells 2.

As shown in FIG. 2, each of the cells 2 is constituted of an MEA 11 and a pair of separators 15a, 15b which nip the MEA 11 therebetween, and the whole constitution has a laminated configuration. The MEA 11 and the respective separators 15a, 15b are substantially flat components having a planar rectangular outer shape, and an outer shape of the MEA 11 is formed to be slightly smaller than that of the separators 15a, 15b.

A peripheral portion between the MEA 11 and the separators 15a, 15b is sealed with first seal members 13a, 13b. Moreover, a frame-like second seal member 13c is disposed between the separators 12a and 12b of the adjacent cells 2, 2.

The MEA 11 is constituted of an electrolytic film 21 including an ion exchange film of a polymer material and a pair of electrodes 22a, 22b (a cathode and an anode) which nip therebetween the electrolytic film 21 from opposite surfaces of the film, and the whole constitution has a laminated configuration.

The electrodes 22a, 22b are constituted of, for example, a porous carbon material (a dispersion layer) bonded to a catalyst such as platinum. An oxidizing gas (a reactant gas) such as air or an oxidizer is supplied to one electrode 22a (the cathode), and a hydrogen gas as a fuel gas (a reactant gas) is supplied to the other electrode 22b (the anode). An electrochemical reaction occurs in the MEA 11 owing to the two gases, and the cells 2 obtain an electromotive force.

The respective separators 15a, 15b are constituted of separator bases 12a, 12b formed of a conductive material impermeable to the gas, and a coat layer 50 which covers the surfaces of the bases. The separator bases 12a, 12b of the present embodiment are plate-like metals, and in the coat layer 50, a coat-forming material 50a having excellent corrosion resistance is applied to the separator bases 12a, 12b and then hardened. As this coat-forming material 50a, a thermosetting resin such as polyimide or epoxy may be used.

In the separators 15a, 15b, portions of the separator bases 12a, 12b which face the electrodes 22a, 22b are pressed, whereby a plurality of concave/convex portions are formed on front and back surfaces of the separators. These plurality of convex and concave portions extend along surface directions of the separator bases 12a, 12b, respectively, and define gas channels (fluid channels) 31a of an oxidizing gas or gas channels (fluid channels) 31b of a hydrogen gas and cooling water channel (fluid channels) 32.

Moreover, one end portion of each of the separators 15a, 15b is provided with a manifold 41 on the side of inlets of the oxidizing gas, the hydrogen gas and the cooling water. The other end portion is similarly provided with an outlet-side manifold (not shown). These manifolds 41 are formed by punching simultaneously with the pressing of the separator bases 12a, 12b to form the concave/convex portions of the channels 31a, 31b and 32.

It is to be noted that these manifolds 41 are separately disposed with respect to the oxidizing gas, the hydrogen gas and the cooling water, respectively, but here the manifolds are denoted with the same reference numeral, and description thereof is omitted.

Next, an edge portion A (see FIG. 2) of a punched portion formed in a case where the manifolds 41 are formed at the separators base 12a, 12b by punching will be described in detail with reference to FIG. 3. As shown in FIG. 3, the coat-forming material 50a formed of, for example, a thermosetting resin is applied to the separator bases 12a, 12b after the pressing, and then subjected to a thermosetting treatment to form the coat layer 50 (see FIG. 4).

The manifolds 41 are formed by the punching during the pressing of the separator bases 12a, 12b, and in this case, as shown in FIG. 3, blade-like burrs 51 having sharp protrusions 51a are sometimes generated at the edge portion A on a front side (on a downside in FIG. 3) in a punching direction. When such protruded burrs 51 are generated, the application of the coat-forming material 50a to this portion easily becomes insufficient, and the separator bases 12a, 12b are corroded from the exposed burrs 51 as starting points.

It is generally thought that a corrosive current is a cause for the corrosion of the separator, but as a result of intensive investigation concerning the cause, the present inventor has obtained a finding that when the separator is provided with protrusions such as the burrs, the corrosive current is concentrated on the protrusion, and therefore the corrosion of the separator is caused from the burrs as the starting points, and based on this finding, the present inventor has reached a technical thought that diminishing of the burrs in the manifold formed by punching is effective for improvement of corrosion resistance.

In other words, a part of the separator where the burrs need to be diminished may be a part in which the burrs are formed by the punching or the like and which comes in contact with a fluid (the reactant gas, a refrigerant), that is, the manifold only. For example, the burr at a portion such as a separator outer periphery or the like which does not come in contact with the fluid may not be subjected to a burr diminishing treatment, and may be left to stand as it is.

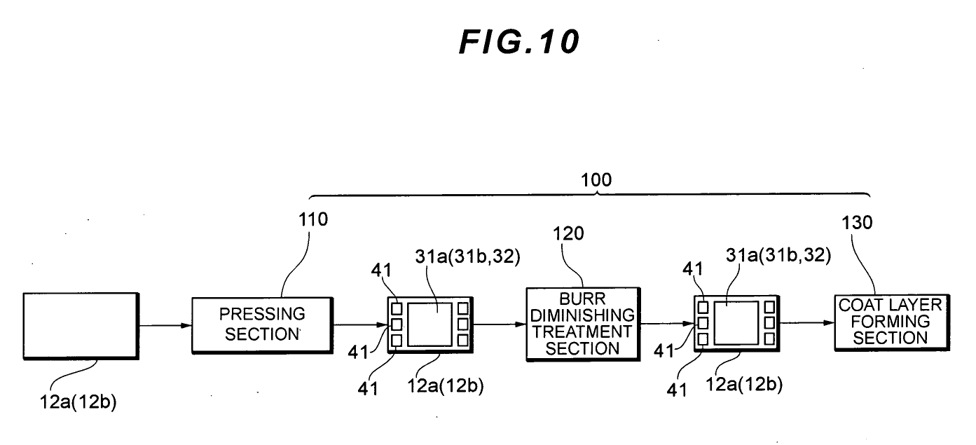

In the present embodiment, in a pressing section 110 of a separator producing apparatus 100 shown in FIG. 10, a step of punching the flat-plate-like separator bases 12a, 12b into a predetermined outer shape, a step of forming the concave/convex portions which define the fluid channels 31a, 31b and 32 by pressing and a step of forming the manifolds 41 by the punching are simultaneously performed. Then, in a burr diminishing treatment section 120, one of the following means (burr removal) (1) to (4) is performed before the coat-forming material 50a for forming the coat layer 50 is applied in a coat layer forming section 130, whereby the burrs 51 in the manifolds 41 formed by the previous step in the pressing section 110 are diminished, and the burrs 51 are more preferably removed.

(1) The edge portion A is electrolytically etched.

(2) The only edge portion A is subjected to the pressing again.

(3) The only edge portion A is subjected to shot blasting. It is to be noted that a portion other than the edge portion A is masked.

(4) The only edge portion is cut.

Among these means, the above means (1) is one step example of a treatment in which at least the protrusions 51a of the burrs 51 are dissolved in an electrolytic etching section as one constitution example of the burr diminishing treatment section 120, whereby the burrs 51 are diminished. The above means (2) and (3) are step examples of a treatment in which an external force is applied to the protrusions 51a of the burrs 51 to deform the protrusions in a pressing section, a shot blasting section or a cutting section as a constitution example of the burr diminishing treatment section 120, whereby the burrs 51 are diminished.

FIG. 4 shows a state in which the burrs 51 are removed by one of the above means (1) to (4), and then the coat-forming material 50a is applied to the whole surfaces of the separator bases 12a, 12b including such burr removed parts (burr diminished parts), and thermally set to form the coat layer 50. As shown in this drawing, according to the present embodiment, the edge portion A from which the burrs have been removed can sufficiently be covered with the coat layer 50. Therefore, corrosion resistance is improved, and improvement of cell durability due to prevention of ion elution and prevention of deterioration of cell performance can be realized.

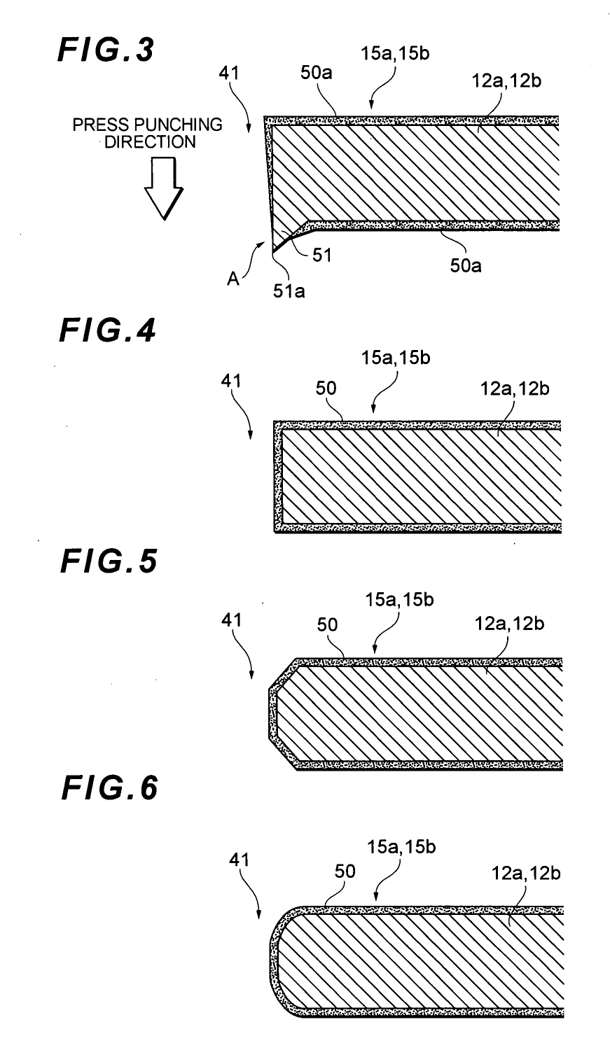

It is to be noted that instead of or in addition to these burr removal (diminishing) means (1) to (4), processing shown in FIGS. 5, 6 may be performed. That is, FIG. 5 is a diagram showing a state in which the edge portion A is flatly chamfered to remove the burrs 51. FIG. 6 is a diagram showing a state in which the edge portion A is roundly chamfered in a convex-surface-like shape to remove the burrs 51.

Even in these modifications shown in FIGS. 5, 6, the burrs 51 of the edge portion A can be removed. In consequence, even when contraction occurs in the coat-forming material 50a during the thermal setting of the coat-forming material 50a, the edge portion A can sufficiently be covered with the coat layer 50. Therefore, the corrosion resistance is improved, and the improvement of the cell durability due to the prevention of the ion elution and the prevention of the deterioration of the cell performance can be realized.

### Second Embodiment

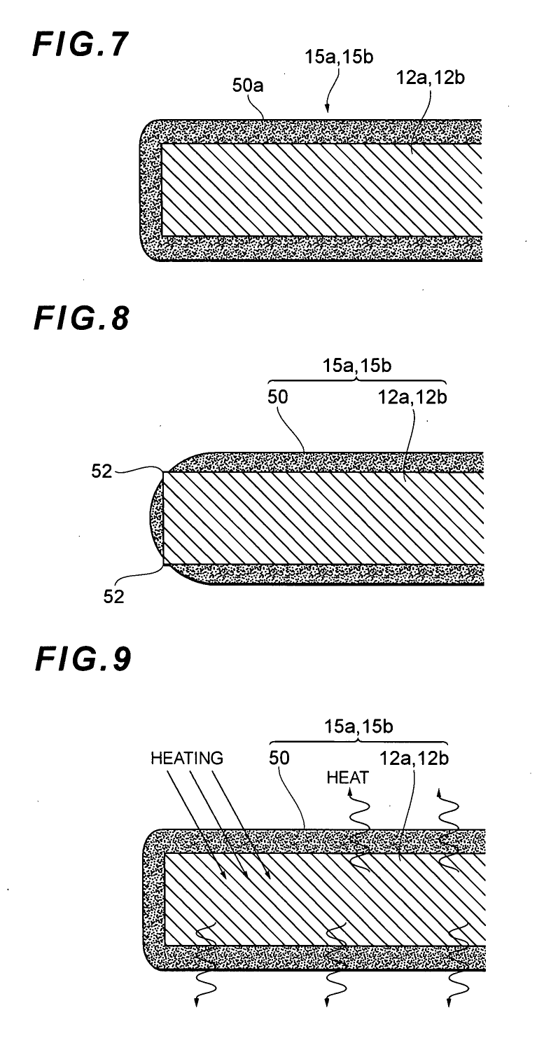

Now, burrs 51 formed at an edge portion A are removed, whereby a coat-forming material 50a applied to separator bases 12a, 12b can cover the whole separator bases 12a, 12b as shown in FIG. 7 before the material is thermally set, but the material contracts along front and back surfaces of separator bases 15a, 15a and an inner peripheral surface of a punched portion during thermal setting, and resultantly edge portions 52 are sometimes exposed as shown in FIG. 8.

Thereupon, when the coat-forming material 50a is thermally set, as shown in FIG. 9, the only separator bases 12a, 12b to which the coat-forming material 50a has been applied may selectively internally be heated using an eddy current, a microwave, an ultrasonic wave or the like. In this case, as a material of the separator bases 12a, 12b, a thermally conductive material of a metal such as iron or stainless steel is employed. As the coat-forming material 50a for forming a coat layer 50, a thermosetting resin such as polyimide or epoxy is employed.

In a case where the separators 15a, 15b are heated from the inside (the separator bases 12a, 12b) in this manner, while resistance heat in the separator bases 12a, 12b conducts from an inner surface to an outer surface of the coat-forming material 50a, the coat-forming material 50a thermally sets. That is, the coat-forming material 50a hardens from the inside of the material which comes in contact with the separator bases 12a, 12b, so that the coat-forming material 50a applied to the separator bases 12a, 12b is more firmly fixed, and such contraction that the coat-forming material 50a escapes from the edge portions 52 can be inhibited.

Therefore, exposure of the edge portions 52 of the separator bases 12a, 12b can be inhibited to prevent corrosion of the separators 15a, 15b. In consequence, improvement of cell durability due to prevention of ion elution, and prevention of deterioration of cell performance can be realized.

### ANOTHER EMBODIMENT

The embodiments of the present invention have been described above in detail with reference to the drawings, but a specific constitution is not limited to the embodiments, and even design change and the like which do not depart from the scope of the present invention are included in the scope of the present invention. For example, a thermosetting resin is employed in the corrosion-resistant coat-forming material for use in the second embodiment, but the corrosion-resistant coat-forming material for use in the first embodiment may not necessarily be the thermosetting resin.

Moreover, in the above embodiments, an example in which the corrosion-resistant coat layer 50 is formed on the whole surfaces of the separator bases 12a, 12b has been described, but in the present invention, burrs of a manifold formed by punching are diminished to improve corrosion resistance. Therefore, application of the present invention is not necessarily limited to a separator having the coat layer, a process for producing the separator and an apparatus for producing the separator, and needless to say, the present invention can be applied to a so-called coatless separator.

### INDUSTRIAL APPLICABILITY

According to the present invention, burrs of a manifold formed by punching are diminished beforehand, so that concentration of a corrosive current on the burrs as starting points can be inhibited. Since exposure of a separator base at an edge portion of a punched portion can be inhibited, proceeding of corrosion of a separator from the exposed portion as a starting point can be inhibited.

Therefore, the present invention can broadly be used in such a required separator, a process for producing the separator and an apparatus for producing the separator.

1. (canceled)

2. A process for producing a metal separator having a fluid channel on at least one side and a manifold communicating with the fluid channel and formed by punching, the process comprising:
a step of diminishing burrs in the manifold formed by the punching,
wherein in the step of diminishing the burrs, at least protrusions of the burrs are dissolved to diminish the burrs.

3. The process for producing the metal separator according to claim 2,
wherein the process comprises a step of diminishing burrs in the manifold formed by the punching, and
in the step of diminishing the burrs, protrusions of the burrs are dissolved by etching.

4. A process for producing a metal separator having a fluid channel on at least one side and a manifold communicating with the fluid channel and formed by punching, the process comprising:
a step of diminishing burrs in the manifold formed by the punching,
wherein in the step of diminishing the burrs, the protrusions are deformed by shot blasting.

5. A process for producing a metal separator according to claim 4,
wherein the process comprises a step of diminishing burrs in the manifold formed by the punching, and
a coat layer made of a resin is further formed on the surface of the metal separator.

6. The process for producing the metal separator according to claim 5, where the burrs have been diminished wherein a portion other than an edge portion of the manifold is masked and subjected to the shot blasting.

7. The process for producing a metal separator having a fluid channel on at least one side and a manifold communicating with the fluid channel and formed by punching, the process comprising:
a step of diminishing burrs in the manifold formed by the punching,
wherein in the step of diminishing the burrs, an external force is applied to roundly deform protrusions of the burrs.

8. The process for producing the metal separator according to claim 4, the process further comprising:
a step of applying a thermosetting coat-forming material to at least a punched portion of the manifold; and
a step of heating the coat-forming material from the side of a separator base.

9. (canceled)

10. An apparatus for producing a metal separator having a fluid channel on at least one side and a manifold communicating with the fluid channel and formed by punching, the apparatus comprising:
a burr diminishing treatment section that diminishes burrs in the manifold formed by the punching,
wherein the burr diminishing treatment section dissolves at least protrusions of the burrs by etching to diminish the burrs.

11. (canceled)

12. An apparatus for producing a metal separator having a fluid channel on at least one side and a manifold communicating with the fluid channel and formed by punching, the apparatus comprising:
a burr diminishing treatment section that diminishes burrs in the manifold formed by the punching,
wherein the burr diminishing treatment section masks a portion other than an edge portion of the manifold to perform shot blasting, and applies an external force to the protrusions of the burrs to deform the protrusions, thereby diminishing the burrs.

13. (canceled)

14. (canceled)
